(19) United States
(12) Patent Application Publication
(10) Pub. No.: US 2020/0384893 A1
(43) Pub. Date: Dec. 10, 2020

(54) METHOD, SYSTEM AND APPARATUS FOR GENERATING SAFETY ALERTS

(71) Applicants: Bethany Anne Dillinger, Plano, TX (US); Gregory Alan Borse, Plano, TX (US)

(72) Inventors: Bethany Anne Dillinger, Plano, TX (US); Gregory Alan Borse, Plano, TX (US)

(21) Appl. No.: 16/782,040

(22) Filed: Feb. 4, 2020

Related U.S. Application Data
(60) Provisional application No. 62/800,650, filed on Feb. 4, 2019.

(51) Int. Cl. B60N 2/00; B60N 2/26

(52) U.S. Cl. CPC B60N 2/002; B60N 2/26

(57) ABSTRACT

Methods, systems and apparatuses to provide life-saving alerts in the event that a child car seat remains occupied under certain unsafe conditions, comprising a software-facilitated means of communication between a short-range radio-enabled sensory device and a mobile device operated by a user. In the event that the sensory device detects that the car child safety seat is occupied and the temperature of the environment has reached or is approaching an unsafe level, the sensory device is operable to send an alert signal to various external devices.

### SUMMARY OF THE DISCLOSED EMBODIMENTS

The present disclosure relates to methods, systems and apparatuses to provide life-saving alerts in the event that a child car seat remains occupied under certain unsafe conditions. With each year that passes, more and more children are becoming victims of being left/forgotten/neglected in a vehicle in which they are strapped in a car seat and unable to escape while temperatures rapidly rise or fall to a deadly level. In many cases, the child is not discovered until it is too late and they have succumbed to the heat or cold.

The presently-disclosed methods, systems and apparatuses aim to provide a simple and applicable solution that any person may install on the car seat they already own, download the corresponding app, integrate and then utilize to register the occupation of their car seat simultaneously with the internal temperature of the car seat's environment in order to set off a series of alerts which will trigger life-saving action for the victim.

Unsafe conditions may include, but are not limited to, an automobile interior exceeding a certain safe temperature range while being occupied. The purpose of the methods, systems and apparatuses disclosed herein is to preserve the lives and health of children trapped in a vehicle that has been locked and turned off.

The goal of improving safety is achieved by undertaking certain alerting actions, which may include one or more of: alerting one or more cellphones with a connected software application, contacting emergency rescue services, activating a GPS location of the vehicle and alerting neighboring devices within range with an “Amber Alert Styled” warning. With the application of this system, no child should be harmed or perish trapped in a car seat in a hot or cold vehicle.

In general, the disclosure relates to a software-facilitated means of communication between a short-range radio-enable sensory device and a mobile device operated by a user. In the event that the sensory device detects that the car child safety seat is occupied and the temperature of the environment has reached or is approaching an unsafe level, the sensory device will send an alert signal to various external devices, which may include: (a) devices running the integrated app, (b) emergency services to initiate rescue and (c) devices within range capable of receiving an “Amber Alert” style push notification. The alert situation will continue until the sensory device detects that the child car safety seat is unoccupied, the temperature of the environment has returned to a safe level, or both.

The systems, methods and apparatuses described herein involve sensory devices employing a short-range wireless communication protocol (such as Bluetooth or similar technology) along with an integrated software application to allow the sensory devices to be attached to any car seat installed in a vehicle, in order to determine: 1.) whether the seat is occupied and 2.) the condition of the environment in which the car seat is situated. In the event that the car seat is occupied and the condition of the automobile interior is determined to be unsafe, the disclosed embodiments are operable to: 3.) communicate with one or more devices running the integrated software application, to alert users of the danger to a child as well as to alert other devices within an established time frame to facilitate a timely life-saving response.

The system operation is first described generally, followed by a specific application of the disclosed system. The system employs sensors in order to determine whether a car seat is occupied and whether the temperature of the environment (inside the vehicle) is unsafe. In certain cases, the sensors may need to be calibrated.

After an initial calibration process, if necessary, the safety system monitors one or more occupancy detection inputs in order to determine whether there is a child in the car seat and whether the environment is dangerous. Depending on the application, the occupancy detection inputs may include weight inputs, sound inputs, temperature inputs, visual inputs, motion inputs or some combination thereof.

The safety system monitors one or more ambient condition inputs to determine whether the interior of the car is unsafe. Depending on the application, the ambient condition inputs may include interior and exterior temperature inputs, date inputs, time inputs, window position inputs, local weather inputs or some combination thereof.

If the safety system determines that the car seat is both occupied and unsafe, the safety system initiates one or more alerting actions. Depending on the application, alerting actions may include sending an alarm to the mobile device containing the integrated app indicating the danger of an occupied car seat and an unsafe temperate, activation of a GPS on the device, calling 911 with location information and an alert regarding the occupied car seat and unsafe conditions, and the distribution of an alert to neighboring phones (the “Good Samaritan” alert) indicating the occupied car seat and unsafe conditions. One specific application of the disclosed system is described below.

At least one embodiment involves a weight sensor and temperature sensor being installed on a car seat which is installed in a vehicle. This embodiment involves the creation of Bluetooth (or other applicable) sensor technology which can register the weight present in the car seat to determine its occupancy and the temperature of the surrounding environment to determine a danger level, as well as a mobile app which can communicate with the technology to register one or a series of alerts to take life-saving action.

Embodiments described herein pertain in general to the software-aided facilitation of electronic automatic communication between the sensor technology and/or mobile devices carried by the end user, emergency alert systems integration, and a perimeter alert sent to compatible devices via push notifications.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 shows certain disclosed embodiments under a condition wherein the interior temperature of an automobile is at an unsafely high level; and

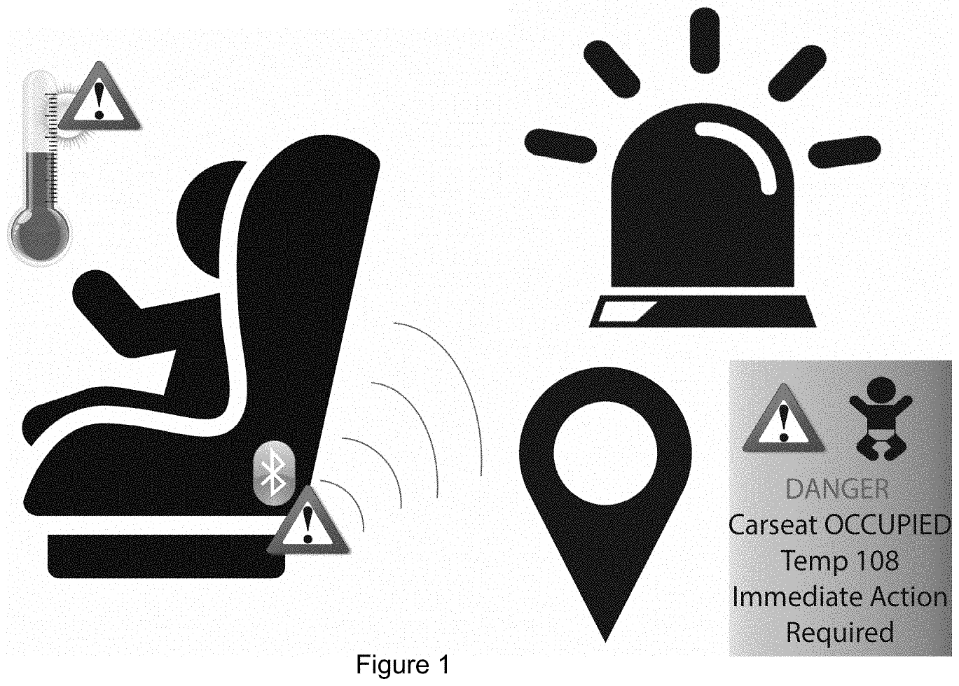

FIG. 2 shows certain disclosed embodiments under a condition wherein the interior temperature of an automobile is at an unsafely low level.

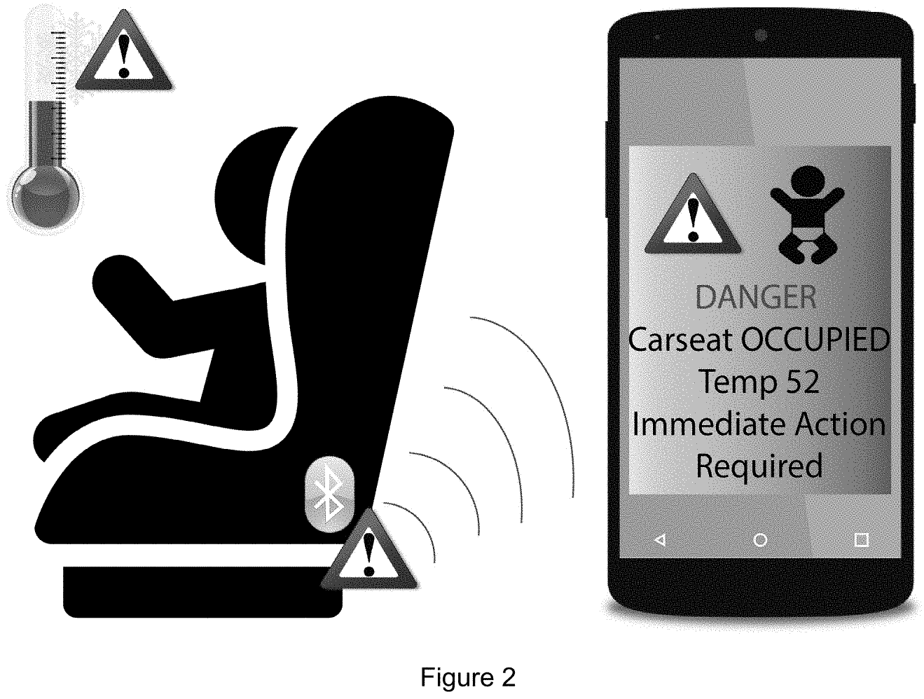

### DETAILED DESCRIPTION OF THE DISCLOSED EMBODIMENTS

While the making and using of various embodiments of the present disclosure are discussed herein, it should be appreciated that the present disclosure provides many applicable inventive concepts, which can be embodied in a wide variety of specific contexts. The specific embodiments discussed herein are merely illustrative and do not delimit the scope of the present disclosure.

In the interest of clarity, not all features of an actual implementation may be described in the present disclosure. It will, of course, be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

The disclosed embodiments involve the integration of the following technologies:
A child safety car seat
A sensory device equipped with short-range radio communication capability (e.g., Bluetooth or similar technology) which registers weight and heat, and is capable of communicating with an external device running a software application.
A software application operably connected to a communications system able to communicate with the sensory device, mobile cellular devices, and emergency alert systems.

The sensory device (Bluetooth or otherwise) will be placed on the car seat in use. This device will be capable of registering the weight in the car seat to determine whether it is occupied or unoccupied. The device will also be capable of registering the temperature of the environment inside the vehicle. The device will be capable of sending all registered information, including but not limited to, occupancy status of the car seat, registered temperature of the environment, date, time, current weather, GPS location, to an interfacing software application running on a connected device, such as a smartphone.

The system owner will install the sensory device on their car seat. They will download the corresponding software application and follow steps to register the app and the sensory device through a series of secure identifiers so that they become communicable.

With the registration of the sensory device and the software application, the system will register the safe environment (non-alert status) including the empty weight of the car seat, and the safe temperature of the environment (vehicle).

Once the child is secured in the car seat, the system will register the weight of the child and will note that the car seat is occupied. The occupied car seat in combination with a safe environmental temperature will be considered above baseline, but safe, and will not trigger an alert.

Baseline conditions include:
An empty car seat PLUS any temperature of the environment as long as the car seat is empty.
An occupied car seat PLUS any temperature of the environment that is safe/below the preset temperature alert level.

The conditions under which the system will trigger an alert will generally be 1.) the registration by the sensory system of a occupied car seat PLUS 2.) the registration of the sensory system of or approaching an unsafe/life-endangering temperature in the environment based on a pre-determined temperature scale.

When these two conditions are met, a series of alerts will be set into motion with the purpose of drawing immediate action from 1.) the system owner 2.) emergency response services and sharing of GPS location 3.) nearby devices via push notifications. These alerts will proceed within the following order and increments.

The alerts and their purposes are as follows when both conditions are met to trigger the alert system:

Alert 1—Device Owner

Alert the system owner via the integrated mobile app that 1.) the car seat is occupied and 2.) the environment has reached or will soon reach an unsafe temperature. This alert will include the location information of the sensor and time stamp the alert.

The device possessing the integrated software app will have the capability to turn off the alert. However, if the alert is silenced and both alert conditions are still met within x minutes (TBD) of the alert being silenced, it will resound the alert.

Alert 2—Emergency Services

If 1.) the alert sent to the device that owns the system is not deactivated and the sensors detect that the dangerous situation has been resolved OR 2.) the alert has been silenced but within a certain period of time the conditions of the alert are still met indicating the danger remains, a second alert will be sent to Emergency Services. This alert will include GPS location information for the whereabouts of the sensor as well as the current conditions including the temperature of the environment and the condition of the car seat being occupied.

Alert 3—Good Samaritans

If, after a certain period of time, the dangerous conditions have not been resolved and the system determines that a predetermined time has passed while the dangerous conditions still exist implying immediate/eminent danger, a push notification will be broadcast to any nearby device which can accept it, displaying a message of nearby danger which may include the location of the device, temperature information and information that the alert pertains to a child in danger.

This notification will function in a similar manner to an Amber Alert and will set off an alarm on the receiving device while displaying pertinent information to allow for the immediate rescue of the child in danger. This alert will not be sounded until an appropriate amount of time has passed to allow the device owner and emergency services to safely amend the dangerous conditions indicated by the system. The purpose of this alert is to allow a passerby to be aware of and acknowledge the situation to take action if the recipients of Alerts 1 and 2 are not present, delayed, or not responding.

In order to prevent unforeseen or unintended harm coming to the child in danger, this alert will take place as a last resort and only when the registration of the two alerting conditions are deemed immediately life-threatening by the system (i.e., interior temperature has reached a dangerous level, but the seat is still occupied.)

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure.

The embodiments have been chosen and described in order to explain the principles of the disclosure and its practical application to enable one skilled in the art to utilize the disclosure in various embodiments and with various modifications as are suited to the particular use contemplated. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

1. A system for providing safety alerts, comprising:
a sensory device operable to determine whether a car child safety seat is occupied and whether the ambient conditions near the child car safety seat pose a safety hazard; and
a software-facilitated communication link between the sensory device and a mobile device, operable to alert the mobile device if the car child safety seat is occupied and the ambient conditions near the child car safety seat pose a safety hazard.
